(19) United States
(12) Patent Application Publication
(10) Pub. No.: US 2026/0036884 A1
(43) Pub. Date: Feb. 5, 2026

(54) CAMERA DEVICE

(71) Applicant: Chicony Electronics Co., Ltd., New Taipei City (TW)

(72) Inventor: Chien-Chung Ou, New Taipei City (TW)

(21) Appl. No.: 19/227,308

(22) Filed: Jun. 3, 2025

(30) Foreign Application Priority Data
Jul. 30, 2024 (TW) 113208126

(51) Int. Cl. G03B 17/12; G03B 11/04

(52) U.S. Cl. CPC G03B 17/12; G03B 11/045

(57) ABSTRACT

A camera device includes a circuit board, a photosensitive element, and a first reinforcement plate. The circuit board has an assembling hole, a first surface, and a second surface opposite to the first surface. The assembling hole penetrates the first surface and the second surface, the assembling hole has an inner annular surface, the first surface has a first groove, and the first groove surrounds a periphery of the assembling hole. The photosensitive element is in the assembling hole, and the photosensitive element has a front surface, a back surface, and an outer peripheral portion. The outer peripheral portion is fixed to the inner annular surface of the assembling hole, and the front surface is nearer to the first surface as compared with the back surface. The first reinforcement plate is disposed in the first groove of the first surface.

### CROSS-REFERENCE TO RELATED APPLICATION

This non-provisional application claims priority under 35 U.S.C. § 119 (a) to patent application Ser. No. 11/320,8126 filed in Taiwan, R.O.C. on Jul. 30, 2024, the entire contents of which are hereby incorporated by reference.

### BACKGROUND

### Technical Field

The instant disclosure relates to an optical device, in particular, to a camera device.

### Related Art

Along with developments of technology, camera devices are widely used in different fields, such as personal electronic products, automobiles, and medical sciences. For example, a camera device may be installed on a computer device (such as a notebook computer or a tablet computer) to support the functions of video recording, on-line meetings, facial recognition, or the like.

### SUMMARY

In general, a camera device known to the inventor includes a circuit board and a photosensitive element. To make the overall thickness of the camera device thinner, the photosensitive element is assembled in the hole of the circuit board. Such configuration although reduces the overall thickness of the camera device, because of the configuration of the hole of the circuit board, displacement or deformation of the circuit board and the photosensitive element may occur easily upon an external force is applied to the circuit board and the photosensitive element, thereby affecting the quality of the image detected by the photosensitive element.

In view of this, in one embodiment, a camera device is provided. The camera device comprises a circuit board, a photosensitive element, and a first reinforcement plate. The circuit board has an assembling hole, a first surface, and a second surface opposite to the first surface. The assembling hole penetrates the first surface and the second surface, and the assembling hole has an inner annular surface. The first surface has a first groove, and the first groove surrounds a periphery of the assembling hole. The photosensitive element is in the assembling hole. The photosensitive element has a front surface, a back surface, and an outer peripheral portion. The outer peripheral portion is fixed to the inner annular surface of the assembling hole, and the front surface is nearer to the first surface as compared with the back surface. The first reinforcement plate is disposed in the first groove of the first surface.

In another embodiment, a camera device is provided. The camera device comprises a circuit board, a photosensitive element, and a second reinforcement plate. The circuit board has an assembling hole, a first surface, and a second surface opposite to the first surface. The assembling hole penetrates the first surface and the second surface, and the assembling hole has an inner annular surface. The second surface has a second groove, and the second groove surrounds a periphery of the assembling hole. The photosensitive element is in the assembling hole. The photosensitive element has a front surface, a back surface, and an outer peripheral portion. The outer peripheral portion is fixed to the inner annular surface of the assembling hole, and the front surface is nearer to the first surface as compared with the back surface. The second reinforcement plate is disposed in the second groove of the second surface.

As above, according to the camera device of one or some embodiments of the instant disclosure, the groove is provided on the first surface or the second surface to surround the periphery of the assembling hole, and the reinforcement plate is further disposed in the groove, so that the structural strength of the region of the circuit board adjacent to the assembling hole can be enhanced. Therefore, upon an external force is applied to the circuit board and the photosensitive element, displacement of the photosensitive element and deformation or breaking of the circuit board can be prevented, so that the photosensitive element can provide proper image sensing quality. Moreover, by disposing the reinforcement plate in the groove, the overall thickness of the camera device is not increased, thereby facilitating the development trend of thinning the camera device.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a camera device according to a first embodiment of the instant disclosure;

FIG. 2 illustrates an exploded view of the camera device of the first embodiment of the instant disclosure;

FIG. 3 illustrates a cross-sectional view of the camera device of the first embodiment of the instant disclosure;

FIG. 4 illustrates an enlarged partial cross-sectional view of the camera device of the first embodiment of the instant disclosure;

FIG. 5 illustrates a bottom view of the camera device of the first embodiment of the instant disclosure;

FIG. 6 illustrates an exploded view of a camera device according to a second embodiment of the instant disclosure;

FIG. 7 illustrates a cross-sectional view of the camera device of the second embodiment of the instant disclosure;

FIG. 8 illustrates an enlarged partial cross-sectional view of the camera device of the second embodiment of the instant disclosure; and

FIG. 9 illustrates an enlarged partial cross-sectional view of a camera device according to a third embodiment of the instant disclosure.

### DETAILED DESCRIPTION

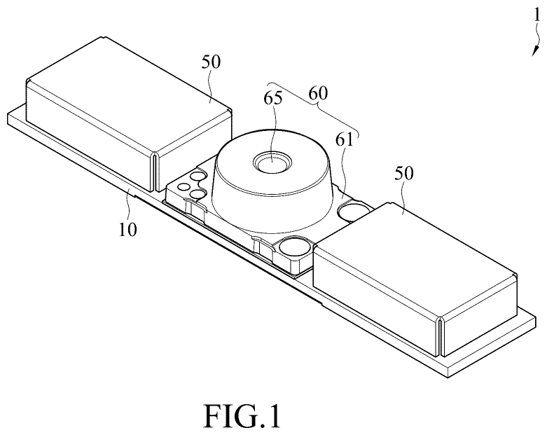

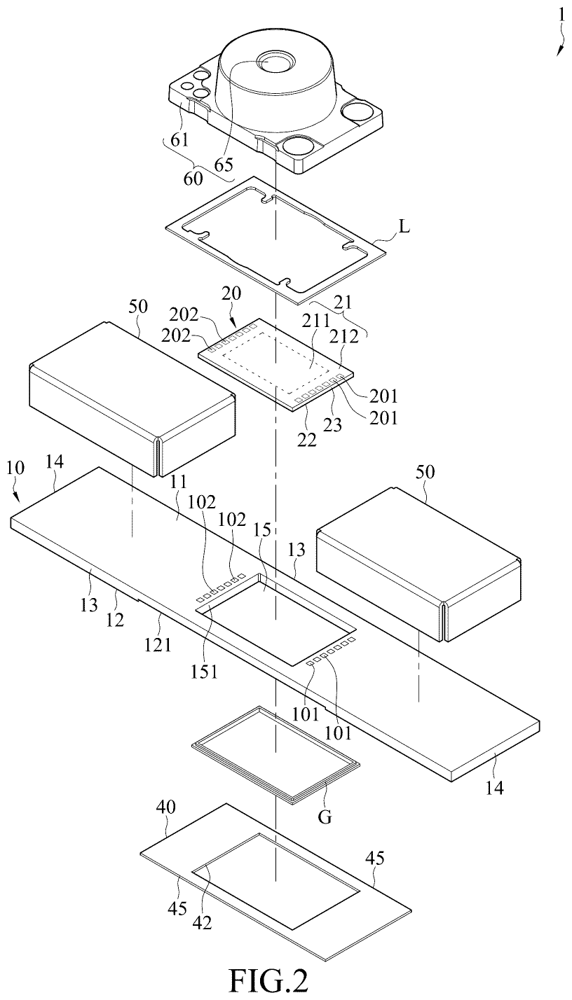

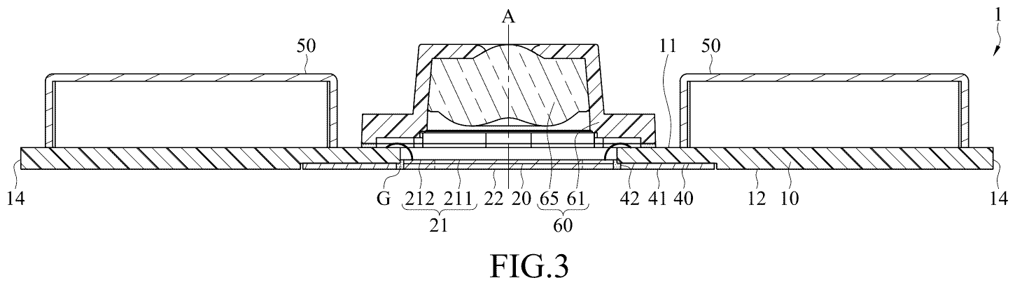

FIG. 1 illustrates a perspective view of a camera device according to a first embodiment of the instant disclosure. FIG. 2 illustrates an exploded view of the camera device of the first embodiment of the instant disclosure. FIG. 3 illustrates a cross-sectional view of the camera device of the first embodiment of the instant disclosure. As shown in FIG. 1 to FIG. 3, the camera device 1 comprises a circuit board 10 and a photosensitive element 20. In some embodiments, the camera device 1 may be utilized in different electronic devices for capturing images around the electronic devices. For example, the camera device 1 may be utilized in mobile devices (e.g., smart phones, tablet computers, or notebook computers), cameras, or other electronic devices.

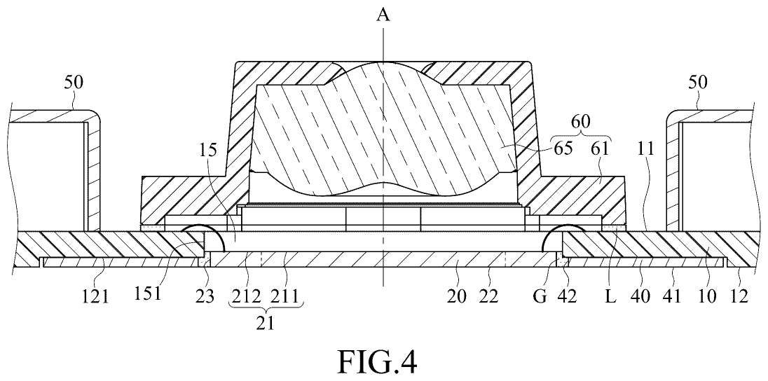

FIG. 4 illustrates an enlarged partial cross-sectional view of the camera device of the first embodiment of the instant disclosure. As shown in FIG. 1 to FIG. 4, the circuit board 10 has a first surface 11, a second surface 12, and an assembling hole 15, where the first surface 11 is opposite to the second surface 12. The assembling hole 15 penetrates the first surface 11 and the second surface 12 and has an inner annular surface 151. In this embodiment, the assembling hole 15 is a rectangular hole, but the instant disclosure is not limited thereto. In other embodiments, the assembling hole 15 may be a round hole, an elliptical hole, a square hole, or the like, depending on the actual product demands.

As shown in FIG. 2 to FIG. 4, the photosensitive element 20 is disposed in the assembling hole 15. The photosensitive element 20 has a front surface 21, a back surface 22, and an outer peripheral portion 23. The outer peripheral portion 23 is connected between the front surface 21 and the back surface 22. The front surface 21 and the first surface 11 of the circuit board 10 face toward the same direction, the back surface 22 and the second surface 12 of the circuit board 10 face toward the same direction, and the front surface 21 is nearer to the first surface 11 of the circuit board 10 as compared with the back surface 22 (in other words, in some embodiments, the distance between the front surface 21 and the first surface 11 of the circuit board 10 is less than the distance between the back surface 22 and the first surface 11 of the circuit board 10). In some embodiments, the shape of the photosensitive element 20 may be the same as the shape of the assembling hole 15; for example, as shown in FIG. 2, in this embodiment, both the shape of the photosensitive element 20 and the shape of the assembling hole 15 are rectangular, but the instant disclosure is not limited thereto, and the photosensitive element 20 may have other shapes (e.g., round, elliptical, or square).

In some embodiments, specifically, the photosensitive element 20 may be a charge-coupled device (CCD), a complementary metal-oxide semiconductor (CMOS), or a CMOS active pixel sensor.

As shown in FIG. 2 to FIG. 4, the camera device 1 comprises a lens assembly 60, and the lens assembly 60 is disposed on the first surface 11 of the circuit board 10 and covers the assembling hole 15. The lens assembly 60 comprises a base 61 and a lens 65, the lens 65 is disposed on the base 61, and the lens assembly 60 is fixed on the first surface 11 of the circuit board 10 through the base 61. For example, in this embodiment, the base 61 is adhesively fixed to the first surface 11 of the circuit board 10 through an adhesive layer L. Moreover, the position of the lens 65 of the lens assembly 60 corresponds to the position of the photosensitive element 20. Therefore, after external light enters the base 61 through the lens 65, the external light can be focused on the photosensitive element 20.

As shown in FIG. 2 to FIG. 4, the outer peripheral portion 23 of the photosensitive element 20 is fixed to the inner annular surface 151 of the assembling hole 15. For example, in this embodiment, the outer peripheral portion 23 of the photosensitive element 20 is adhesively fixed to the inner annular surface 151 of the assembling hole 15 through an annular adhesive layer G. Therefore, during the manufacturing process of the camera device 1, the photosensitive element 20 can be disposed in the assembling hole 15 in advance, and the effects of dust, moisture, or other foreign objects in the ambient environment on the photosensitive element 20 can be reduced before the assembling hole 15 becomes an enclosed space. Moreover, because the photosensitive element 20 is not stacked on the surface of the circuit board 10, the overall thickness of the camera device 1 can be reduced. Therefore, when the photosensitive element 20 is adhered to the inner annular surface 151 and the assembling hole 15 is covered by the lens assembly 60, the assembling hole 15 and the interior of the lens assembly 60 thus can become an enclosed space.

In some embodiments, the camera device 1 may further comprise a first reinforcement plate 30 or may further comprise a second reinforcement plate 40; alternatively, in some embodiments, the camera device 1 may comprise both the first reinforcement plate 30 and the second reinforcement plate 40 at the same time. Such embodiments are described with the aids of drawings.

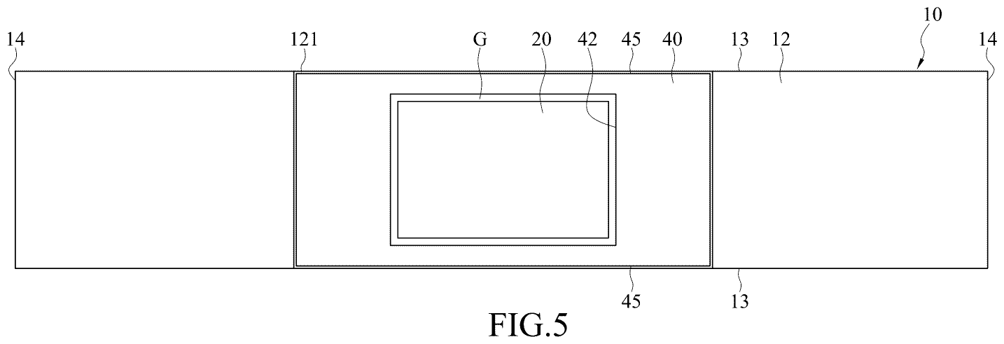

FIG. 5 illustrates a bottom view of the camera device of the first embodiment of the instant disclosure. As shown in FIG. 2 to FIG. 5, in this embodiment, the second surface 12 of the circuit board 10 has a second groove 121, and the second groove 121 is an annular groove surrounding the periphery of the assembling hole 15. The camera device 1 comprises a second reinforcement plate 40, and the second reinforcement plate 40 is an annular plate and disposed in the second groove 121 of the second surface 12 to surround the periphery of the assembling hole 15. For example, the second reinforcement plate 40 may be adhesively fixed in the second groove 121 through adhesives. Therefore, the structural strength of the region of the circuit board 10 adjacent to the assembling hole 15 can be enhanced through the second reinforcement plate 40. Specifically, it is understood that, because of the configuration of the assembling hole 15, the region of the circuit board 10 adjacent to the assembling hole 15 is prone to be bent upon the region is subjected to an external force. As a result, under such circumstances, when the circuit board 10 and the photosensitive element 20 are subjected to an external force, the photosensitive element 20 is displaced and thus does not correspond to the focal length of the lens, or the circuit board 10 is deformed or broken. Consequently, according to one or some embodiments of the instant disclosure, the second reinforcement plate 40 is fixed to the second groove 121 of the second surface 12 of the circuit board 10, so that the structural strength of the circuit board 10 can be enhanced and the robustness of the combination between the photosensitive element 20 and the circuit board 10 can be also enhanced, thereby increasing the overall structural strength of the camera device 1. Therefore, upon an external force is applied to the circuit board 10 and the photosensitive element 20, displacement of the photosensitive element 20 and deformation or breaking of the circuit board 10 can be prevented, so that the photosensitive element 20 can provide proper image sensing quality. Moreover, because the second reinforcement plate 40 is received within the second groove 121 and does not protrude from the second surface 12, the overall thickness of the camera device 1 is not increased thereby facilitating the development trend of thinning the camera device 1, while the structural strength of the lens assembly 60 can be enhanced.

As shown in FIG. 2 to FIG. 5, in this embodiment, the circuit board 10 is rectangular and has two long sides 13 opposite to each other and two short sides 14 opposite to each other, the second reinforcement plate 40 has two second sides 45 opposite to each other, and the two second sides 45 are respectively adjacent to or flush with the two long sides 13 of the circuit board 10 (as shown in FIG. 5). Therefore, the coverage of the second reinforcement plate 40 can be increased as much as possible, thereby further enhancing the overall structural strength of the camera device 1.

As shown in FIG. 2 to FIG. 5, at least one fixed shield 50 is on the first surface 11 of the circuit board 10. In this embodiment, two fixed shields 50 are on the first surface 11; for example, each of the fixed shields 50 may be fixed on the first surface 11 through adhering, engaging, locking, or other manner so as to protect the electronic components on the circuit board 10. Moreover, in this embodiment, the two fixed shields 50 are respectively at two opposite sides of the lens assembly 60, the photosensitive element 20 has a central axis A, and a region of the fixed shield 50 and a region of the second reinforcement plate 40 are overlapped with each other along the central axis A. In this embodiment, one side of each of the fixed shields 50 adjacent to the lens assembly 60, a region of the second reinforcement plate 40, and a region of the circuit board 10 adjacent to the assembling hole 15 are stacked with each other along the central axis A. Therefore, after the circuit board 10, the fixed shields 50, and the second reinforcement plate 40 are assembled with each other, the overall structural strength of the camera device 1 can be further enhanced.

As shown in FIG. 5, in this embodiment, the second reinforcement plate 40 has a second outer surface 41, and the second outer surface 41 of the second reinforcement plate 40, the second surface 12 of the circuit board 10, and the back surface 22 of the photosensitive element 20 may be arranged on the same plane. Therefore, the side of the camera device 1 away from the lens assembly 60 is configured as a uniform surface and can be assembled on surfaces of other components conveniently. Moreover, because the second reinforcement plate 40 does not protrude from the second surface 12, the thickness of the camera device 1 is not increased while the second reinforcement plate 40 still can provide reinforcement function for the camera device 1.

As shown in FIG. 2 and FIG. 4, in this embodiment, the second reinforcement plate 40 has an inner annular flange 42, and the annular adhesive layer G is not only adhered to the outer peripheral portion 23 of the photosensitive element 20 and the inner peripheral surface 151 of the assembling hole 15 but also further adhered to the inner annular flange 42 of the second reinforcement plate 40. Therefore, the photosensitive element 20 is further connected and fixed to the second reinforcement plate 40. Hence, the circuit board 10, the photosensitive element 20, and the second reinforcement plate 40 can be adhered with each other through the annular adhesive layer G, thereby enhancing the overall structural strength of the camera device 1 and preventing the displacement or deformation of the photosensitive element 20 upon an external force is applied to the photosensitive element 20.

Further, as shown in FIG. 2 to FIG. 4, the front surface 21 of the photosensitive

element 20 has a photosensitive region 211 and a non-photosensitive region 212, and the non-photosensitive region 212 surrounds the periphery of the photosensitive region 211. In FIG. 2, for the sake of convenience and understanding, the front surface 21 of the photosensitive element 20 is divided into the photosensitive region 211 and the non-photosensitive region 212 through a dashed line. In some embodiments, the photosensitive element 20 may be made of semiconductor materials. The photosensitive region 211 may have tiny photosensitive units for detecting external light so that the photosensitive region 211 can generate an image, while the non-photosensitive region 212 is a region which does not participate light detection and image generation. For example, the non-photosensitive region 212 may be electrically connected to the circuits on the circuit board 10 for signal transmission.

For example, as shown in FIG. 2, the non-photosensitive region 212 of the photosensitive element 20 has a first conductive portion 201 and a second conductive portion 202, and the first conductive portion 201 and the second conductive portion 202 are respectively adjacent to two opposite sides of the photosensitive region 211. The first surface 11 of the circuit board 10 has a first electrical connection portion 101 and a second electrical connection portion 102, and the first electrical connection portion 101 and the second electrical connection portion 102 are respectively at the two opposite sides of the assembling hole 15. The first electrical connection portion 101 is adapted to be electrically connected to the first conductive portion 201, and the second electrical connection portion 102 is adapted to be electrically connected to the second conductive portion 202, so that signals can be transmitted between the photosensitive element 20 and the circuit board 10. For example, in this embodiment, each of the first conductive portion 201, the second conductive portion 202, the first electrical connection portion 101, and the second electrical connection portion 102 may comprise a plurality of conductive contacts, the conductive contacts of the first electrical connection portion 101 may be electrically connected to the conductive contacts of the first conductive portion 201 through conductive wires, and the conductive contacts of the second electrical connection portion 102 may be electrically connected to the conductive contacts of the second conductive portion 202 through conductive wires.

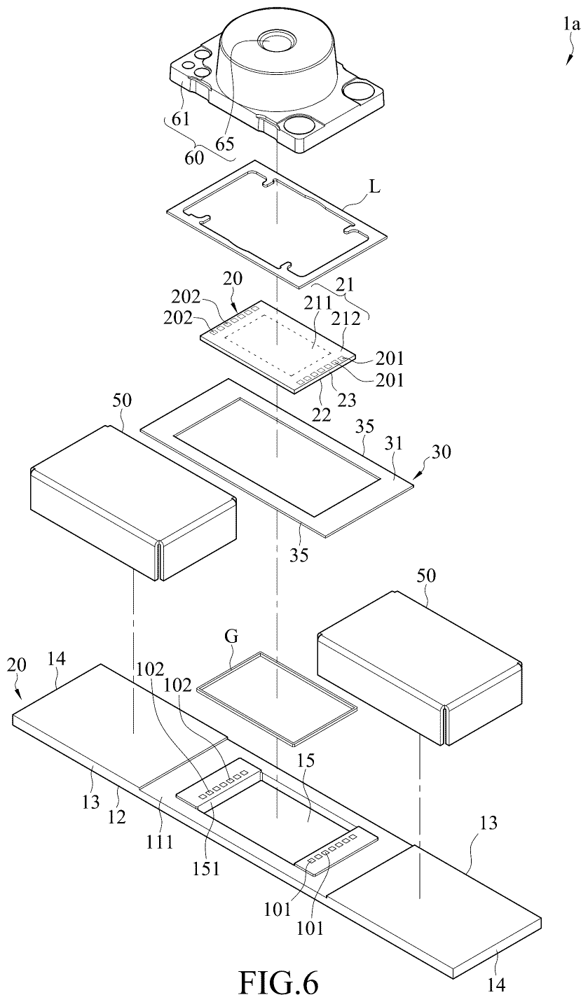

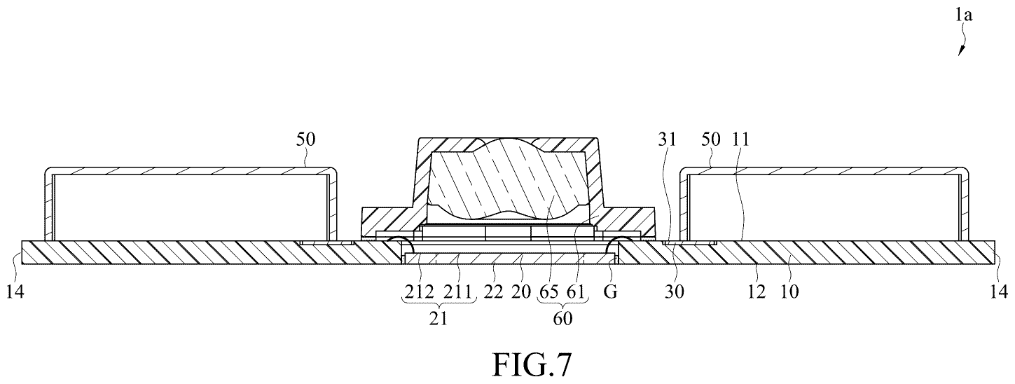

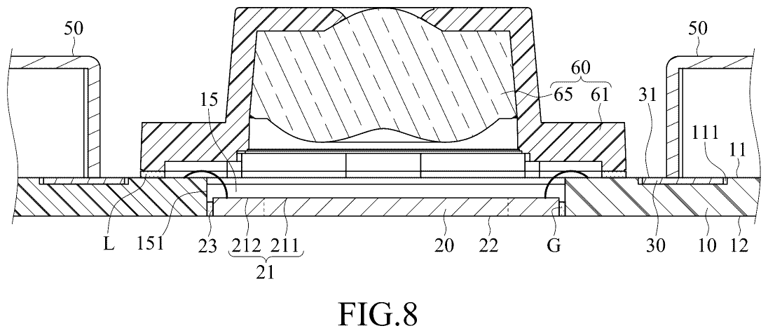

FIG. 6 illustrates an exploded view of a camera device according to a second embodiment of the instant disclosure. FIG. 7 illustrates a cross-sectional view of the camera device of the second embodiment of the instant disclosure. FIG. 8 illustrates an enlarged partial cross-sectional view of the camera device of the second embodiment of the instant disclosure. As shown in FIG. 6 to FIG. 8, the difference between the second embodiment and the first embodiment at least lies in that, according to the camera device 1a of this embodiment, the circuit board 10 only has a first groove 111 on the first surface 11, and the first groove 111 is an annular groove surrounding the periphery of the assembling hole 15. The camera device 1a comprises a first reinforcement plate 30, the first reinforcement plate 30 is an annular plate and disposed in the first groove 111 of the first surface 11 to surround the periphery of the assembling hole 15; for example, the first reinforcement plate 30 may be adhesively fixed in the first groove 111 through adhesives. Therefore, through the first reinforcement plate 30, the structural strength of the circuit board 10 also can be enhanced and the robustness of the combination between the photosensitive element 20 and the circuit board 10 can be also enhanced, thereby increasing the overall structural strength of the camera device 1a. Therefore, upon an external force is applied to the circuit board 10 and the photosensitive element 20, displacement of the photosensitive element 20 and deformation or breaking of the circuit board 10 can be prevented. Moreover, because the first reinforcement plate 30 is received within the first groove 111 and does not protrude from the first surface 11, the overall thickness of the camera device 1a is not increased thereby facilitating the development trend of thinning the camera device 1a, while the structural strength of the lens assembly 60 can be enhanced.

As shown in FIG. 6, in this embodiment, the first electrical connection portion 101 and the second electrical connection portion 102 of the first surface 11 of the circuit board 10 are respectively at the two opposite sides of the assembling hole 15, and the first groove 111 surrounds the periphery of the first electrical connection portion 101 and the periphery of the second electrical connection portion 102. In other words, in this embodiment, the first electrical connection portion 101 and the second electrical connection portion 102 are not in the first groove 111, otherwise the first reinforcement plate 30 will cover the first electrical connection portion 101 and the second electrical connection portion 102, and the first electrical connection portion 101 and the second electrical connection portion 102 thus cannot be electrically connected to the first conductive portion 201 and the second conductive portion 202 of the photosensitive element 20.

As shown in FIG. 6 to FIG. 8, in this embodiment, the first reinforcement plate 30 has two first sides 35 opposite to each other, and the two first sides 35 are respectively adjacent to or flush with the two long sides 13 of the circuit board 10. Therefore, the coverage of the first reinforcement plate 30 can be increased as much as possible, thereby further enhancing the overall structural strength of the camera device 1a.

As shown in FIG. 6 to FIG. 8, likewise, two fixed shields 50 are on the first surface 11 of the circuit board 10. The first reinforcement plate 30 has a first outer surface 31, and a region of each of the fixed shields 50 contacts the first outer surface 31. For example, in this embodiment, one side of each of the fixed shields 50 adjacent to the lens assembly 60 leans against the first outer surface 31 of the first reinforcement plate 30. Therefore, after the circuit board 10, the fixed shields 50, and the first reinforcement plate 30 are assembled with each other, the overall structural strength of the camera device 1a can be further enhanced.

As shown in FIG. 6 to FIG. 8, the first outer surface 31 of the first reinforcement plate 30 and the first surface 11 of the circuit board 10 may be arranged on the same plane. Therefore, because the first reinforcement plate 30 does not protrude from the first surface 11, the thickness of the camera device 1a is not increased while the first reinforcement plate 30 still can provide reinforcement function for the camera device a.

In some embodiments, the structural strength of the first reinforcement plate 30 and the structural strength of the second reinforcement plate 40 may be greater than the structural strength of the circuit board 10. For example, the material of the first reinforcement plate 30 and the material of the second reinforcement plate 40 may be different from the material of the circuit board 10, and the tensile strength, the compressive strength, or the bending strength of the first reinforcement plate 30 and the tensile strength, the compressive strength, or the bending strength of the second reinforcement plate 40 may be greater than the tensile strength, the compressive strength, and or bending strength of the circuit board 10. For example, the material of the first reinforcement plate 30 and the material of the second reinforcement plate 40 may be metal or fiber-reinforced plastic, and the material of the circuit board 10 may be glass fiber or epoxy resin. Therefore, the first reinforcement plate 30 and the second reinforcement plate 40 can sustain a greater pressure as compared with the circuit board 10 so that the first reinforcement plate 30 and the second reinforcement plate 40 do not break, deform, or damage easily.

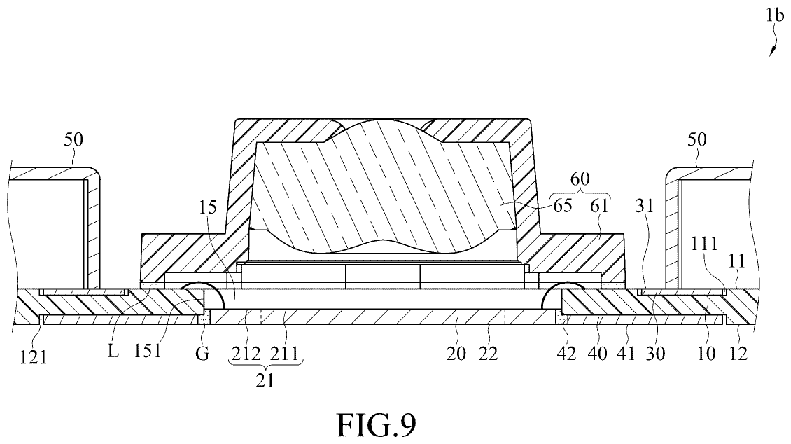

FIG. 9 illustrates an enlarged partial cross-sectional view of a camera device according to a third embodiment of the instant disclosure. As shown in FIG. 9, the difference between the third embodiment and the first embodiment and the second embodiment at least lies in that, according to the camera device 1b of this embodiment, the first surface 11 of the circuit board 10 has a first groove 111, and the second surface 12 of the circuit board 10 has a second groove 121; the camera device 1b comprises a first reinforcement plate 30 and a second reinforcement plate 40, the first reinforcement plate 30 is disposed in the first groove 111 of the first surface 11, and the second reinforcement plate 40 is disposed in the second groove 121 of the second surface 12. Therefore, both the structural strengths of the first surface 11 and the second surface 12 of the circuit board 10 can be enhanced, thereby further enhancing the structural strength of the circuit board 10. Accordingly, upon an external force is applied to the circuit board 10 and the photosensitive element 20, displacement of the photosensitive element 20 and deformation or breaking of the circuit board 10 can be prevented.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A camera device comprising:
a circuit board having an assembling hole, a first surface, and a second surface opposite to the first surface, wherein the assembling hole penetrates the first surface and the second surface, the assembling hole has an inner annular surface, the first surface has a first groove, and the first groove surrounds a periphery of the assembling hole;
a photosensitive element in the assembling hole, wherein the photosensitive element has a front surface, a back surface, and an outer peripheral portion, the outer peripheral portion is fixed to the inner annular surface of the assembling hole, and the front surface is nearer to the first surface as compared with the back surface; and
a first reinforcement plate disposed in the first groove of the first surface.

2. The camera device according to claim 1, wherein the circuit board has two long sides opposite to each other and two short sides opposite to each other, the first reinforcement plate has two first sides opposite to each other, and the two first sides are respectively adjacent to or flush with the two long sides.

3. The camera device according to claim 1, wherein a fixed shield is on the first surface, the first reinforcement plate has a first outer surface, and a region of the fixed shield contacts the first outer surface.

4. The camera device according to claim 1, wherein the first reinforcement plate has a first outer surface, and the first outer surface and the first surface of the circuit board are arranged on the same plane.

5. The camera device according to claim 1, wherein the second surface has a second groove, the second groove surrounds the periphery of the assembling hole, and a second reinforcement plate is disposed in the second groove.

6. A camera device comprising:
a circuit board having an assembling hole, a first surface, and a second surface opposite to the first surface, wherein the assembling hole penetrates the first surface and the second surface, the assembling hole has an inner annular surface, the second surface has a second groove, and the second groove surrounds a periphery of the assembling hole;
a photosensitive element in the assembling hole, wherein the photosensitive element has a front surface, a back surface, and an outer peripheral portion, the outer peripheral portion is fixed to the inner annular surface of the assembling hole, and the front surface is nearer to the first surface as compared with the back surface; and
a second reinforcement plate disposed in the second groove of the second surface.

7. The camera device according to claim 6, wherein the circuit board has two long sides opposite to each other and two short sides opposite to each other, the second reinforcement plate has two second sides opposite to each other, and the two second sides are respectively adjacent to or flush with the two long sides.

8. The camera device according to claim 6, wherein a fixed shield is on the first surface, the photosensitive element has a central axis, and a region of the fixed shield and a region of the second reinforcement plate are overlapped with each other along the central axis.

9. The camera device according to claim 6, wherein the second reinforcement plate has a second outer surface, and the second outer surface and the second surface of the circuit board are arranged on the same plane.

10. The camera device according to claim 9, wherein the second outer surface of the second reinforcement plate, the second surface of the circuit board, and the back surface of the photosensitive element are arranged on the same plane.

11. The camera device according to claim 6, wherein the outer peripheral portion of the photosensitive element and the inner annular surface of the assembling hole are adhesively fixed with each other through an annular adhesive layer.

12. The camera device according to claim 11, wherein the second reinforcement plate has an inner annular flange, and the annular adhesive layer is further adhered to the inner annular flange.
